(19) United States
(12) Patent Application Publication
(10) Pub. No.: US 2003/0033483 A1
(43) Pub. Date: Feb. 13, 2003

(54) Cache architecture to reduce leakage power consumption

(76) Inventor: Dennis M. O'Connor, Chandler, AZ (US)

Correspondence Address: Timothy N. Trop, TROP, PRUNER & HU, P.C., 8554 KATY FWY, STE 100, HOUSTON, TX, 77024-1805, US

(21) Appl. No.: 09/928,671

(22) Filed: Aug. 13, 2001

(51) Int. Cl. G06F 13/00

(52) U.S. Cl. 711/122; 711/133

(57) ABSTRACT

By dividing a cache into a core and a level 2 cache, faster components may be used in the core and slower components may be used in the level 2 cache. Functions that do not need to use the faster components, including the logic to manage the core, may be placed in a level 2 cache. As a result, the core may be of reduced size and multilevel cache with reduced leakage current may result in some embodiments.

### BACKGROUND

This invention relates to the caches, including the L1 or level 1 and L2 or level 2 caches normally associated with microprocessors.

Conventional microprocessor architecture schemes use an L1 and an L2 cache to temporarily store instructions, state information, functions, and other information.

The level 1 instruction caches service requests for instructions generated by instruction prefetchers. The level 1 data cache caches service memory data read and write requests generated by the processor's execution units when they are executing instructions that require a memory data access.

The level 2 cache resides on the dedicated bus and services misses on the level 1 cache. In the event of a level 2 cache miss, the level 2 cache issues a transaction request to an external bus unit to obtain the requested instruction or data line from external memory. The information is placed in the level 2 cache and is also forwarded to the appropriate level 1 cache for storage.

When the prefetcher requests a line of code from a code cache, the request results in a hit or a miss. In the event of a miss, the code cache issues a request to the level 2 cache. A look-up is performed in the level 2 cache indicating a hit or a miss. In the case of a hit, the requested line is supplied to the code cache. If the request results in a level 2 cache miss, the level 2 cache issues a request and the line is read from external memory.

As semiconductor devices become smaller and smaller, leakage power consumption considerations become more and more important, especially for mobile applications. As a result, leakage power consumption may become a significant contributor to total power dissipation.

Thus, there is a need for ways to design multilevel caches to reduce cache leakage power consumption.

### BRIEF DESCRIPTION OF THE DRAWINGS

FIG. 1 is a schematic depiction of a multilevel cache in accordance with one embodiment of the present invention;

FIG. 2 is a schematic depiction of a processor-based system in accordance with one embodiment of the present invention;

FIG. 3 is a flow chart for software for handling a read miss in accordance with one embodiment of the present invention; and

FIG. 4 is a flow chart for software for maintaining cache coherency in accordance with one embodiment of the present invention.

### DETAILED DESCRIPTION

In accordance with some embodiments of the present invention, power dissipation may be reduced by placing frequently used, time critical functions and state information in a first level cache containing relatively fast components that necessarily have relatively higher leakage currents. Other functionality may be migrated to a second level cache made up of slower components that have lower leakage current. The functionality that remains in the faster, higher leakage components may be referred to herein as the core.

In the cache hierarchy then, functions that remain in the core may include things such as tags, valid bits and the data itself. In some embodiments, the core may include debug and analysis and trace flags, as well as access control attribute bits. In one embodiment, virtual addresses may be utilized to index the core to avoid the need for an address translation mechanism, such as a translation look aside buffer (TLB). This use of virtual addressing may reduce the amount of state in the core and the number of nodes that are toggled during instruction execution.

In addition, the L1 caches may be write-through to reduce complexity and to enable certain functions to be performed in the L2 cache. In some embodiments, line replacement policy may be implemented by the L2 instead of the L1 cache.

Management of the L1 cache may be implemented by the L2 cache or caches implemented in slower devices with lower leakage currents. In addition to the usual L2 mechanisms, the L2 cache may contain mechanisms for managing L1 cache line replacement, performing virtual-to-physical translation, ensuring L1 cache coherency and determining the access attributes of memory regions.

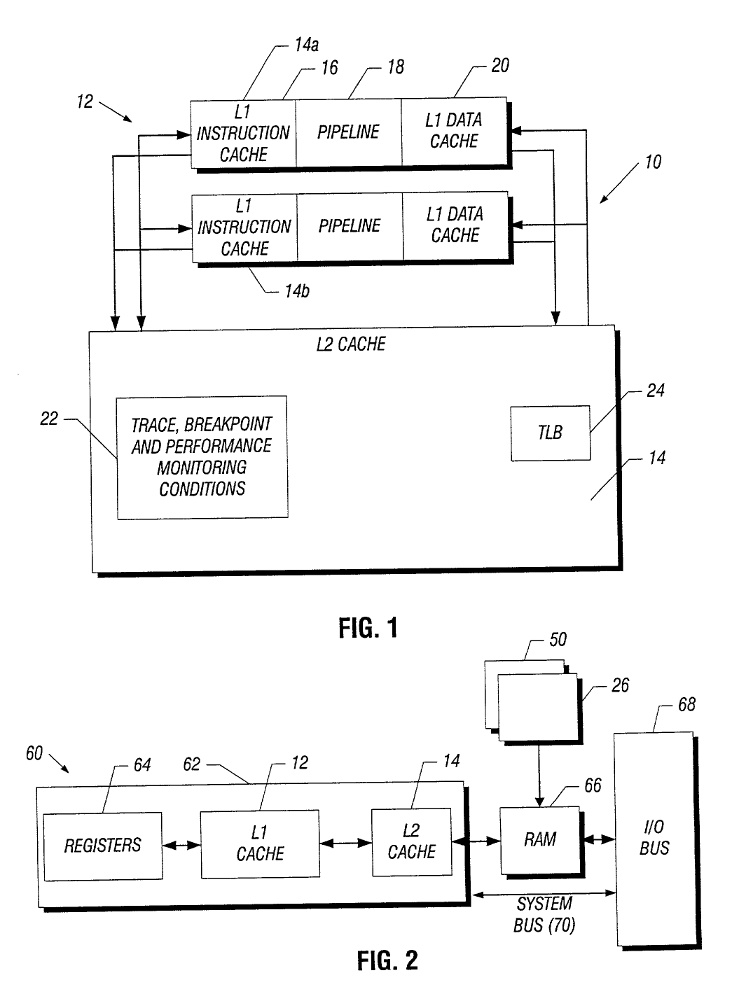

Referring to FIG. 1, the L1 cache 12 may be connected by a high bandwidth link to the L2 cache 14. In accordance with one embodiment of the present invention, the L2 cache may be a unified L2 cache. In another embodiment of the present invention, a single core or two more cores may be utilized in systems with separate L2 caches for instructions and data. The L1 cache 12 may include an instruction cache 16, a pipeline 18 and a data cache 20. Two separate L1 caches 14a and 14b may be provided in one embodiment. As a result, cache management logic, snooping support, debugging and monitoring mechanisms and virtual-to-physical translation may be removed from the L1 caches while still supporting, by a mechanisms in the L2 cache, L1 cache coherency, trace, breakpoints, performance monitoring and virtual memory in the L2 cache 14 as indicated in block 22.

As a result, the L2 cache 14 can be made simpler, may be faster and may be more energy efficient because only the higher leakage current components that are needed are utilized and all other functions are diverted to a lower leakage L2 cache 14.

Referring next to FIG. 2, a processor-based system 60 may include an integrated circuit 62 that includes the L1 cache 12 as well as the L2 cache 14 in one embodiment. Register 64 may be coupled to the L1 cache 12. The integrated circuit 62 communicates with a random access memory (RAM) 66. Software 50 and 26 may be stored in the RAM 66. The input/output (I/O) bus 68 communicates with the RAM 66 and the integrated circuit 62 through the system bus 70.

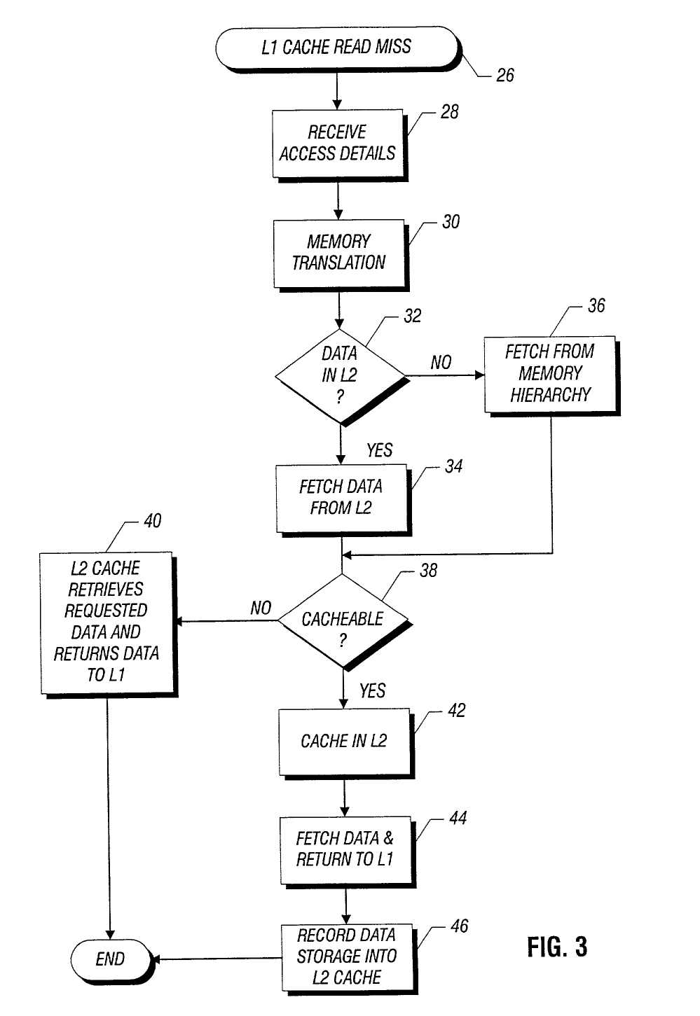

Referring to FIG. 3, the software 26 for handling a L1 read miss via the L2 cache 14 is illustrated. On a L1 cache read miss, an L1 cache 12 passes the details of the access to the L2 cache as indicated in block 28. These details may include, for example, the type, size, virtual address and destination register.

The L2 cache 14 may then use its memory translation mechanism, such as a translation look aside buffer to determine the physical address and attributes of the access as indicated in block 30. The L2 cache may also check to see if the requested data is in the L2 cache 14 as determined in diamond 32. If the attributes indicate access, the requested data may be fetched from memory (either from the L2 cache or from further out in the memory hierarchy) as indicated in block 36. If the data is in the L2 cache 14, it may be fetched from the L2 cache 14 as indicated in block 34.

A check at diamond 38 determines whether the access was cacheable. The L2 cache 14 ensures that the data is cached in the L2 cache 14 and then fetches data the width and alignment of an entire L1 cache 12 line and returns the data to the L1 cache as indicated in blocks 42 and 44. Along with the data, information may be sent to the L2 cache 14 as indicated above. The access attributes are read from a translation look aside buffer, any relevant breakpoint, performance monitoring and trace tags, the way within the set to store the line into and a signal indicating that the indicated way in the appropriate set should be replaced with the data and tags given as indicated in block 44. The information indicating which way the data was stored into the L1 cache is also recorded in the corresponding line of the L2 cache for future use as indicated in block 46. If there are multiple L1 caches served by the same L2 cache, storage for the L1 cache location information may be available for each L1 cache.

There are a number of ways that the L2 cache may determine which way of the L1 to replace. A pseudo-random scheme may be used or there may be a mapping or partial mapping between which L2 cache way contains the data and which L1 cache way contains the data, or any number of L2 or possibly even L1 access or replacement history schemes may be used in other embodiments.

If the access was not cacheable as determined in diamond 38, and the access is legal, the L2 cache may retrieve exactly the requested data. The requested data may be returned to the L1 cache as indicated in block 40 along with the original information sent to the L2 cache and a signal indicating that the data should not be stored in the L1 cache.

All data loaded into the L1 instruction caches are executable. The only attributes that the L2 instruction cache stores are those related to breakpoint, trace, or performance monitoring events, in one embodiment.

There is no need to record in the L1 data cache whether the memory region that the line is mapped into is cacheable or not. Depending on whether there are write buffers in the core, where the region is bufferable may or may not be one of the attributes stored in the L1 cache. Whether the memory can be written to or not is an attribute stored in the cache. Flags that indicate that a trace, performance counter, or breakpoint event should occur may be part of the L1 cache attributes. The granularity of these flags (one per line, one per word, or some other scheme) and other specifics are architecture and implementation dependent.

Turning to FIG. 3, the L2 cache can snoop the bus leading further out in the memory hierarchy. In addition, since all L1 caches served by the L2 cache are write-through, the L2 cache sees all modifications made by the core it serves. Since the L2 cache is inclusive (all valid lines in the L1 caches have corresponding valid lines in the L2 caches), any change to memory cached in an L1 cache is also a change to memory cached in the L2 cache.

When the L2 cache notes a change to its contents, the L2 cache checks the affected line to see which, if any, of the L1 caches also have the address cached. The L2 cache then uses the information it has stored about which way each L1 cache is using to store the information, and sends each affected L1 cache an address, a way designator, and a signal indicating that that way of that set should be invalidated. Alternatively, the L2 cache sends an address, a way, the new data and its size and a signal indicating that the data supplied should be written into the appropriate set in the indicated way.

The L1 cache may be virtually indexed and the L2 cache may be physically indexed. The index is the same for both in some embodiments. The mapping within each L2 cache line of which L1 cache way within each set holds the data in that L2 line serves as a physical-to-virtual address translation. Thus, if two cores were served by the same L2 cache, and each was using different address mapping so that each was accessing the same physical address through two different virtual addresses, both would still be properly updated to maintain cache coherence.

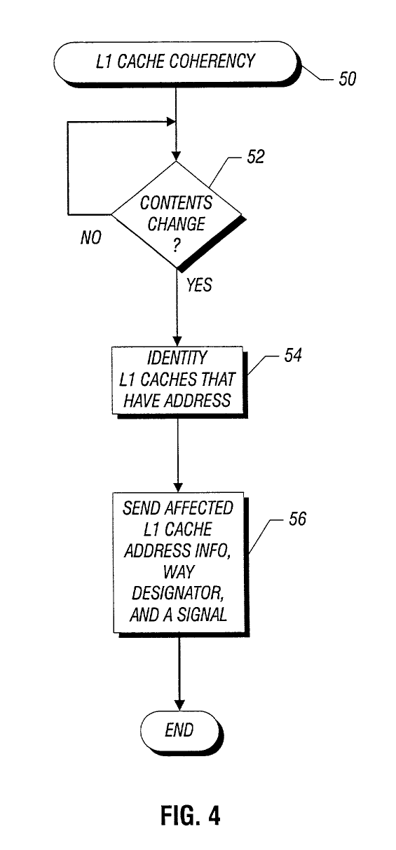

Thus, referring to FIG. 4, the software 50 determines whether there is a change of contents at diamond 52. If so, the identity of the L1 caches that have the address are determined as indicated in block 54. The affected L1 cache address information, way designator and a signal are sent (block 56).

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
defining a multilevel cache including a core having relatively faster components and a region including relatively slower components; and
managing the core from said region.

2. The method of claim 1 including managing the core from a level 2 cache.

3. The method of claim 1 including using a virtual address to index the core to avoid the need for an address translation mechanism.

4. The method of claim 1 including placing functions relating to tags and valid bits as well as the data itself in the core.

5. The method of claim 1 including using a write-through core cache.

6. The method of claim 1 including implementing a line replacement policy in said region.

7. The method of claim 1 including performing virtual-to-physical translation in said region.

8. The method of claim 1 including handling a core cache miss by passing the details of the access to said region.

9. The method of claim 8 including enabling said region to use a memory translation mechanism to determine the physical address and attributes of the access.

10. The method of claim 9 including checking to see if the requested data is in a storage associated with said region.

11. An article comprising a medium storing instructions that enable a processor-based system to:
define a multilevel cache including a core having relatively faster components and a region including relatively slower components; and
manage the core from said region.

12. The article of claim 11 further storing instructions that enable the processor-based system to manage the core from a level 2 cache.

13. The article of claim 11 further storing instructions that enable the processor-based system to use a virtual address to index the core to avoid the need for an address translation mechanism.

14. The article of claim 11 further storing instructions that enable the processor-based system to access functions relating to tags and valid bits as well as the data itself in the core.

15. The article of claim 11 further storing instructions that enable the processor-based system to use a write-through core cache.

16. The article of claim 11 further storing instructions that enable the processor-based system to implement a line replacement policy in said region.

17. The article of claim 11 further storing instructions that enable the processor-based system to perform virtual-to-physical translation in said region.

18. The article of claim 11 further storing instructions that enable the processor-based system to handle a core cache miss by passing the details of the access to said region.

19. The article of claim 18 further storing instructions that enable the processor-based system to enable said region to use a memory translation mechanism to determine the physical address and attributes of the access.

20. The article of claim 19 further storing instructions that enable the processor-based system to check to see if the requested data is in a storage associated with said region.

21. A system comprising:
a processor;
a multilevel cache including a core having relatively faster components and a region including relatively slower components; and
a storage coupled to said processor storing instructions that enable the processor to manage the core from said region.

22. The system of claim 21 wherein said storage stores instructions that enable the processor to manage the core from a level 2 cache.

23. The system of claim 21 wherein said storage stores instructions that enable the processor to use a virtual address to index the core to avoid the need for an address translation mechanism.

24. The system of claim 21 wherein said storage stores instructions that enable the processor to place functions relating to tags and valid bits as well as the data itself in the core.

25. The system of claim 21 wherein said core cache is a write-through cache.

26. The system of claim 21 wherein said storage stores instructions that enable the processor to implement a line replacement policy in said region.

27. The system of claim 21 wherein said storage stores instructions that enable the processor to perform virtual-to-physical translation in said region.

28. The system of claim 21 wherein said storage stores instructions that enable the processor to handle a core cache miss by passing the details of the access to said region.

29. The system of claim 28 wherein said storage stores instructions that enable the processor to enable said region to use a memory translation mechanism to determine the physical address and attributes of the access.

30. The system of claim 29 wherein said storage stores instructions that enable the processor to check to see if the requested data is in a storage associated with said region.
